(19) United States
(12) Patent Application Publication
(10) Pub. No.: US 2022/0022486 A1
(43) Pub. Date: Jan. 27, 2022

(54) DEVICE FOR PREPARING A FROZEN FOOD PRODUCT FROM A LIQUID MIXTURE AND A METHOD FOR OPERATING THE DEVICE

(71) Applicant: Frederik Van Isacker, Zaventem (BE)

(72) Inventor: Frederik Van Isacker, Zaventem (BE)

(73) Assignee: KEMPISCHE BRIK CENTRALE, Zaventem (BE)

(21) Appl. No.: 17/021,861

(22) Filed: Sep. 15, 2020

Related U.S. Application Data
(63) Continuation of application No. PCT/EP2020/070862, filed on Jul. 23, 2020.

(51) Int. Cl. A23G 9/12; A23G 9/22

(52) U.S. Cl. CPC A23G 9/12; B01F 7/1605; A23G 9/22

(57) ABSTRACT

A device for preparing frozen food product from a liquid mixture includes: a cup holder for a cup for preparing the frozen food product, a cooling unit for cooling the cavity, a stirring unit for stirring liquid mixture in the cup with a stirring element driven with a motor, a torque sensor for measuring torque applied by the motor, and a control unit configured for: starting an operational phase of the device, monitoring in a first period before a first time the torque of the motor, determining a linear increase of the torque in the first period, monitoring, after the first time, the torque of the motor, and if with respect to the linear increase of the torque in the first period an increase above a threshold occurs in the monitored torque, then initiating an ice cream termination phase, otherwise a sorbet termination phase.

### TECHNICAL FIELD

The present disclosure relates to a device for preparing a frozen food product, such as for example ice cream or sorbet, from a liquid mixture. The present disclosure also relates to a method for operating a device for preparing a frozen food product from a liquid mixture.

### BACKGROUND

EP 0 162 023 A2 shows a device for preparing a frozen food product, more specifically ice cream, from a liquid mixture. The device comprises a cup arranged in a cavity, in which cup the ice cream is to be prepared from the liquid mixture in an operational phase of the device. The device comprises a cooling unit configured for cooling the cavity of the cup holder in the operational phase. The device comprises a stirring unit configured for stirring the liquid mixture in the cup by a stirring element in the operational phase for preparing the ice cream. The stirring unit comprises a drive system for driving a stirring motion of the stirring element in the cup by a motor. The device comprises a current sensor configured for measuring an electrical current going to the motor, which electrical current is indicative of the torque applied by the motor to the stirring element when the ice cream is prepared in the cup from the liquid mixture. The device is configured such that the operational phase is terminated once the torque measured by the current sensor is above a predetermined threshold indicative of the ice cream having reached the right consistency for eating.

The disadvantage of this device is that it is only configured for optimally preparing ice cream as a frozen food product, and not for optimally preparing other types of frozen food product, such as for example sorbet. Hence, preparing other types of frozen food product in this device would lead to bad results, such as for example the frozen food product having the wrong consistency. And even if the device would be provided with additional configurations for optimally preparing other types of frozen food product, then the device would not be able to distinguish during preparation what type of frozen food product is being prepared, and would thus not be able to select the correct configuration for that type of frozen food product.

### SUMMARY

It is an aim of the present disclosure to provide a device for preparing a frozen food product from a liquid mixture, wherein the device is able to determine the type of frozen food product that is being prepared, and terminate for each determined type of frozen food product the preparation of the frozen food product, such that the frozen food. product has the right consistency for eating.

This aim or others is achieved according to the disclosure with a device for preparing a frozen food product from a liquid mixture showing the technical characteristics of the first independent claim.

Therefore, the present disclosure provides a device for preparing a frozen food product from a liquid mixture. In some embodiments, the frozen food product is one of ice cream and sorbet. The device comprises a cup holder comprising a cavity for releasably receiving a cup in which the frozen food product is to be prepared from the liquid mixture in an operational phase of the device. The device comprises a cooling unit configured for cooling the cavity of the cup holder in the operational phase. The device comprises a stirring unit configured for stirring the liquid mixture in the cup by a stirring element in the operational phase for preparing the frozen food product. The stirring unit comprises a drive system for driving a stirring motion of the stirring element in the cup by a motor. The device comprises a torque sensor configured fix measuring a torque applied by the motor. The device comprises a control unit configured for operating the device. The control unit is at least operatively connected to the cooling unit, the motor of the drive system of the stirring unit, and the torque sensor. The control unit is configured for starting the operational phase of the device. In some embodiments, the unit is configured for starting the operational phase of the device by activating the cooling unit for cooling the cavity of the cup holder, and by activating the motor for driving the stirring motion of the stirring element in the cup. The control unit is configured for monitoring, in a first period of the operational phase between the start of the operational phase and a predetermined first time, by the torque sensor the torque applied by the motor for driving the stirring motion of the stirring element in the cup The control unit is configured for determining a linear increase of the torque monitored in the first period. The control unit is configured for monitoring, after the first time, by the torque sensor the torque applied by the motor for driving the stirring motion of the stirring element in the cup. The control unit is configured for, if with respect to the linear increase of the torque determined in the first period an increase above a predetermined threshold occurs in the torque monitored after the first time, initiating a termination phase for ice cream, and otherwise initiating a termination phase for sorbet.

The inventor has found that during the preparation of a frozen food product such as ice cream and sorbet, the consistency of the liquid mixture and over time the frozen food product, and thus also the torque that has to be applied by the motor for driving the stirring motion of the stirring element in the cup containing the liquid mixture and over time the frozen food product, initially increases linearly in the first period between a start time of the operational phase and the first time. However, after the first time the consistency of the liquid mixture for ice cream, and thus also the torque that has to be applied by the motor for driving the stirring motion of the stirring element, starts to rise significantly with respect to the linear increase in the first period, whereas after the first time the consistency of the liquid mixture for sorbet, and thus also the torque that has to be applied by the motor for driving the stirring motion of the stirring element, keeps increasing linearly in the same manner as in the first period.

The device of the present disclosure beneficially makes use of this difference in the torque applied by the motor while preparing the frozen food product from the liquid mixture, to determine the type of frozen food product that is being prepared. Therefore, the control unit determines in the first period by the torque sensor the linear increase in the torque. If, after the first time the torque starts to increase faster than the linear increase determined in the first period, then the control unit initiates the termination phase for ice cream, such that the operational phase of the device is stopped at the moment the ice cream has the right consistency for eating. If, after the first time the torque keeps increasing linearly such as in the first period, then the control unit initiates the termination phase for sorbet, such that the operational phase of the device is stopped at the moment the frozen food product has the right consistency for eating. The inventor has found that in this way, the type of frozen food product can be accurately determined during preparation of the frozen food product with a low margin of error.

In an embodiment of the device according to the present disclosure the termination phase for ice cream comprises monitoring by the torque sensor the torque applied by the motor for driving the stirring motion of the stirring element in the cup, and stopping the operational phase when the torque monitored in the termination phase for ice cream reaches a predetermined first torque.

The inventor has found that ice cream has the right consistency for eating when the torque applied by the motor for driving the stirring motion of the stirring element while preparing the ice cream reaches the predetermined first torque.

In an embodiment of the device according to the present disclosure the termination phase for sorbet comprises stopping the operational phase a predetermined second period after the first time.

The inventor has found that sorbet reaches the right consistency when the liquid mixture for sorbet is stirred after the first time for the predetermined second period. Contrary to the case of ice cream the end condition for sorbet is thus not determined by the torque applied by the motor, but by the time that the liquid mixture is stirred after the first time. This difference in end condition makes it clear that it is important to timely determine the type of frozen food product that is being prepared.

In an embodiment of the device according to the present disclosure stopping the operational phase comprises instructing the cooling unit to stop cooling the cavity of the cup holder, and instructing the motor to stop driving the stirring motion of the stifling element in the cup.

In an embodiment of the device according to the present disclosure monitoring the torque in the first period comprises measuring at least two torque values at different times in the first period by the torque sensor.

Measuring two torque values at different times in the first period is sufficient for determining the linear increase of the torque monitored in the first period, and this can be done without requiring much computing power from the control unit. Increasing the number of measured torque values is however beneficial for improving the accuracy of the determination of the linear increase from the torque monitored in the first period. This reduces the risk of incorrectly determining after the first time whether ice cream or sorbet is being prepared.

In an embodiment of the device according to the present disclosure determining the linear increase of the torque monitored in the first period comprises fitting a line to the measured at least two torque values.

In an embodiment of the device according to the present disclosure the predetermined threshold is based on a standard deviation of at least one parameter of the line fitted to the measured at least two torque values.

In an embodiment of the device according to the present disclosure monitoring the torque after the first time comprises measuring at least one torque value at different times after the first time.

Measuring one torque value after the first time is sufficient for determining if the torque increases after the first time above the increase that would be expected from the linear increase determined in the first period, and this can be done without requiring much computing power from the control unit. Increasing the number of measured torque values is however beneficial for improving the accuracy of determining the torque increase after the first time. This reduces the risk of incorrectly determining after the first time whether ice cream or sorbet is being prepared.

In an embodiment of the device according to the present disclosure monitoring the torque after the first time is done in a first 50% of a predetermined second period after the first time, preferably in a first 40% of a predetermined second period after the first time, and more preferably in a first 30% of a predetermined second period after the first time. In an embodiment of the device according to the present disclosure monitoring the torque after the first time is done after a first 5% of a predetermined second period after the first time, and preferably after a first 10% of a predetermined second period after the first time.

It is beneficial to quickly determine after the first time whether ice cream or sorbet is being prepared, such that the correct termination phase can be timely activated. It is however also beneficial to wait a. sufficient amount of time after the first time where, in case of ice cream, the torque applied by the motor already shows a significant increase with respect to the increase to be expected from the linear increase determined in the first period, This reduces the risk of incorrectly determining the type of frozen food product that is being prepared.

In an embodiment of the device according to the present disclosure the motor is an electrical motor. The torque sensor comprises a current sensor for measuring an electrical current going to the motor. At least one of the torque sensor and the control unit is configured for determining from the electrical current measured by the current sensor the torque applied by the motor.

The present disclosure further provides a method for operating the device for preparing a frozen food product from a liquid mixture according to the present disclosure. In some embodiments, the frozen food product is one of ice cream and sorbet. The method comprises the step performed by the control unit of starting the operational phase of the device. In some embodiments, the method comprises the step performed by the control unit of starting the operational phase of the device by activating the cooling unit for cooling the cavity of the cup holder, and by activating the motor for driving the stirring motion of the stirring element in the cup. The method comprises the step performed by the control unit of monitoring, in a first period of the operational phase between the start of the operational phase and a predetermined first time, by the torque sensor the torque applied by the motor for driving the stirring motion of the stirring element in the cup. The method comprises the step performed by the control unit of determining a linear increase of the torque monitored in the first period. The method comprises the step performed by the control unit of monitoring, after the first time, by the torque sensor the torque applied by the motor for driving the stirring motion of the stirring element in the cup. The method comprises the step performed by the control unit of, if with respect to the linear increase of the torque determined in the first period an increase above a predetermined threshold occurs in the torque monitored after the first time, initiating a termination phase for ice cream, and otherwise initiating a termination phase for sorbet.

In an embodiment of the method according to the present disclosure the termination phase for ice cream comprises monitoring by the torque sensor the torque applied by the motor for driving the stirring motion of the stirring element in the cup, and stopping the operational phase when the torque monitored in the termination phase for ice cream reaches a predetermined first torque.

In an embodiment of the method according to the present disclosure the termination phase for sorbet comprises stopping the operational phase a predetermined second period after the first time,

In an embodiment of the method according to the present disclosure stopping the operational phase comprises instructing the cooling unit to stop cooling the cavity of the cup holder, and instructing the motor to stop driving the stirring motion of the stirring element in the cup.

In an embodiment of the method according to the present disclosure monitoring the torque in the first period comprises measuring at least two torque values at different times in the first period by the torque sensor.

In an embodiment of the method according to the present disclosure determining the linear increase of the torque monitored in the first period comprises fitting a line to the measured at least two torque values.

In an embodiment of the method according to the present disclosure the predetermined threshold is based on a standard deviation of at least one parameter of the line fined to the measured at least two torque values.

In an embodiment of the method according to the present disclosure monitoring the torque after the first time comprises measuring at least one torque value at different times after the first time.

In an embodiment of the method according to the present disclosure monitoring the torque after the first time is done in a first 50% of a predetermined second period after the first time, preferably in a first 40% of a predetermined second period after the first time, and more preferably in a first 30% of a predetermined second period after the first time. In an embodiment of the method according to the present disclosure monitoring the torque after the first time is done after a first 5% of a predetermined second period after the first time, and preferably after a first 10% of a predetermined second period after the first time.

### DESCRIPTION OF THE DRAWINGS

The disclosed subject matter will be further elucidated by the following description and the appended figures.

FIG. 1 shows a device for preparing a frozen food product from a liquid mixture according to an embodiment of the present disclosure.

FIG. 1B shows the device of FIG. 1 A where a protection screen is omitted for illustration purposes,

FIG. 2A shows a cross section through the cup holder of the device of FIG. 1A.

FIG. 2B shows a cross section through the cup holder of the device of FIG. 1A, wherein a cup is received in the cavity of the cup holder.

FIG. 3A shows the drive system of the device of FIG. 1A with a connected stirring element arranged in a cup.

FIG. 3B shows a cross section through the drive system as shown in FIG. 3A.

FIG. 4 shows a perspective view of the stirring element of the device of FIG. 1A.

FIG. 5A shows a perspective view of a cup according to an embodiment of the present disclosure.

FIG. 5B shows a top view of the cup of FIG. 5A.

FIG. 6 shows a graph of the torque applied by the motor to the stirring element as a function of time when preparing ice cream

FIG. 7 shows a schematic representation of the connections of the control unit of the device of FIG. 1A with further components of the device.

### DETAILED DESCRIPTION

The present disclosure will be described with respect to particular embodiments and with reference to certain drawings but the disclosure is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the disclosure.

Furthermore, the terms first, second, third and the like in the description and in the claims, are used for distinguishing between similar elements and not necessarily for describing a sequential or chronological order. The terms are interchangeable under appropriate circumstances and the embodiments of the disclosure can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the disclosure described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present disclosure, the only relevant components of the device are A and B.

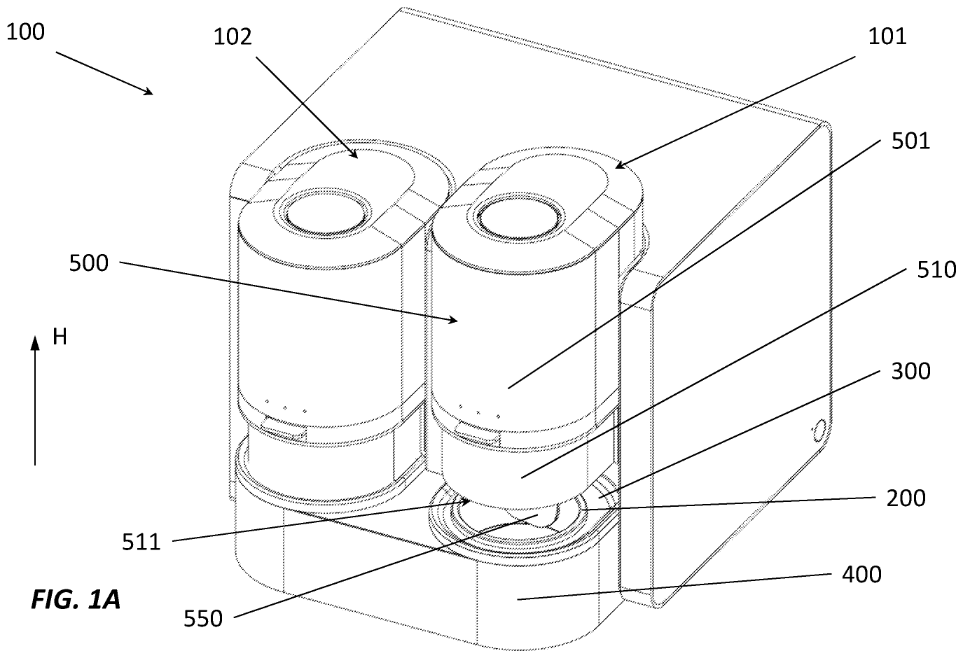

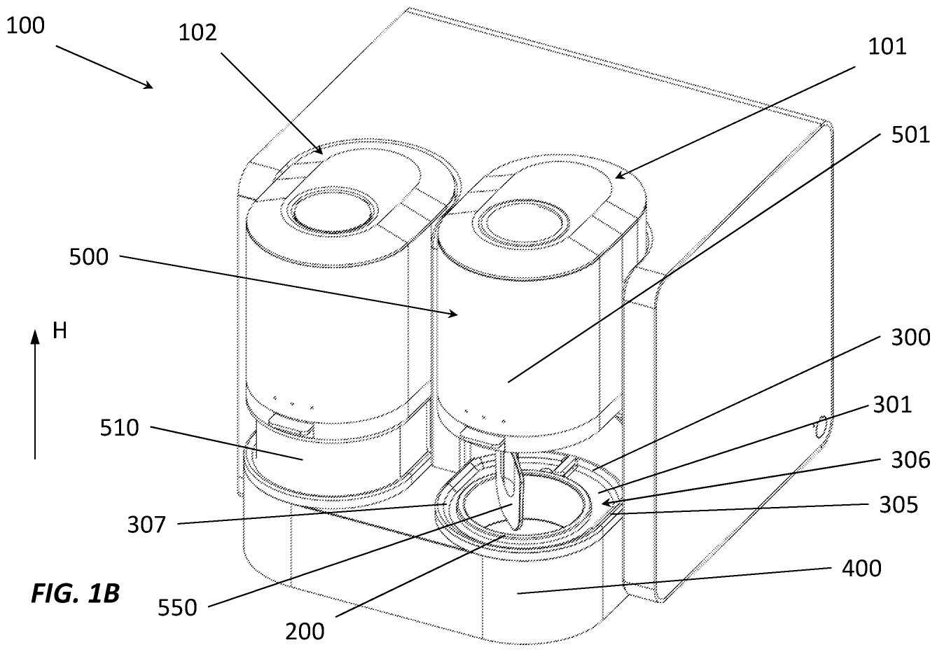

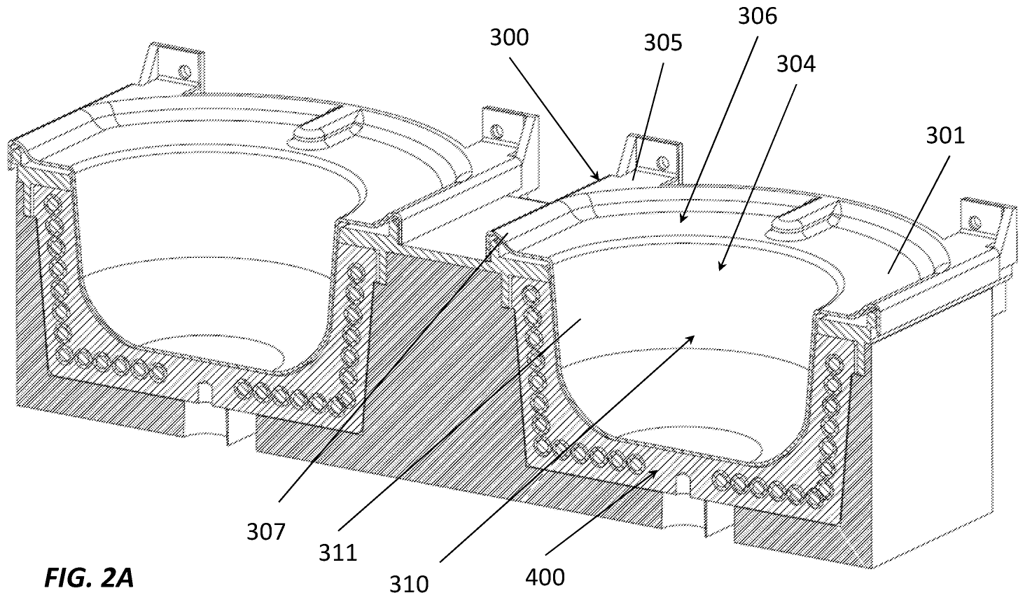

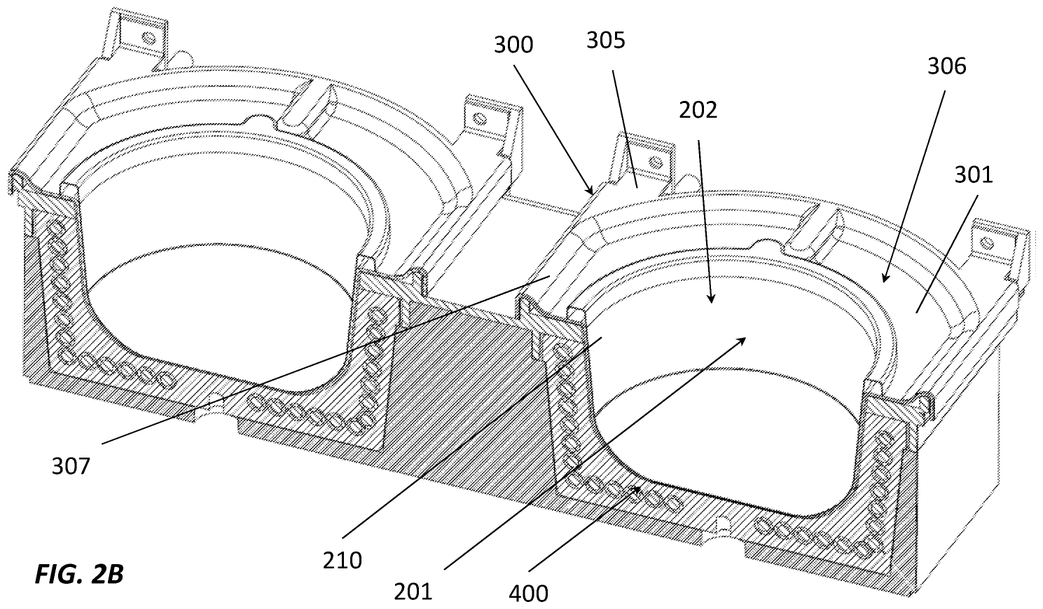

FIGS. 1A and 1B show a device 100 according to an embodiment of the present disclosure for preparing a frozen food product, such as for example ice cream or sorbet, from a liquid mixture. Further details of the device 100 are shown in the FIGS. 2A, 2B, 3A, 33, 4 and 7. The device 100 comprises a first sub-unit 101 which is arranged for preparing a frozen food product in a first cup 200, and a second sub-unit 102 which is arranged for preparing a frozen food product in a second cup 200, different from the first cup 200. The first sub-unit 101 and the second sub-unit 102 are arranged in a similar manner and operate independent from each other, such that two cups 200 of frozen food product can be prepared separate from each other. In alternative embodiments, the device 100 may comprise only a single sub-unit 101, 102. or may be provided with more than two of the sub-units 101, 102, Since the first sub-unit 101 and the second sub-unit 102 are arranged in similar manner, the features of the device 100 will be discussed below only with respect to one of the sub-units 101, 102.

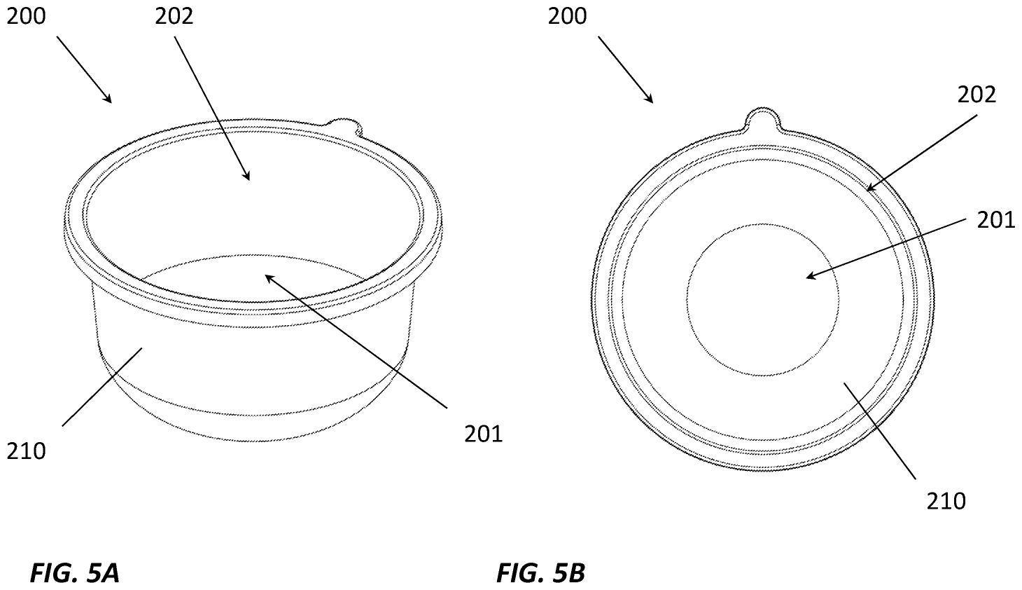

FIGS. 5A and 5B show a cup 200 for use with the device 100. The cup 200 comprises a cup wall 210 which encloses a holding volume 201. The holding volume 201 is arranged for holding the liquid mixture therein, and also for holding the frozen food. product therein after the frozen food product has been prepared form the liquid mixture. At the top, the cup 200 comprises a top opening 202 via which the holding volume 201 can be accessed. The cup 200 may be pre-filled with the liquid mixture, whereby the top opening 202 is sealed off by one or more sealing elements (not shown), such as a sealing membrane and a lid. The sealing elements can then be taken off the cup 200 before the cup 200 is to be used with the device 100. The cup 200 may also be a reusable cup 200, which is filled with a liquid mixture from a package pre-filled with liquid mixture or with a self-made liquid mixture right before the cup 200 is to be used with the device 100.

The device 100 comprises, as can be seen in FIGS. 1A and 19 and shown in more detail in FIGS. 2A and 2B, at its bottom a cup holder 300 which is arranged for holding the cup 200, preferably in a fixed position, while the frozen food product is being prepared in the cup 200. Therefore, the device 100 comprises a cavity 310 in which the cup 200 can be received via an entrance opening 304.

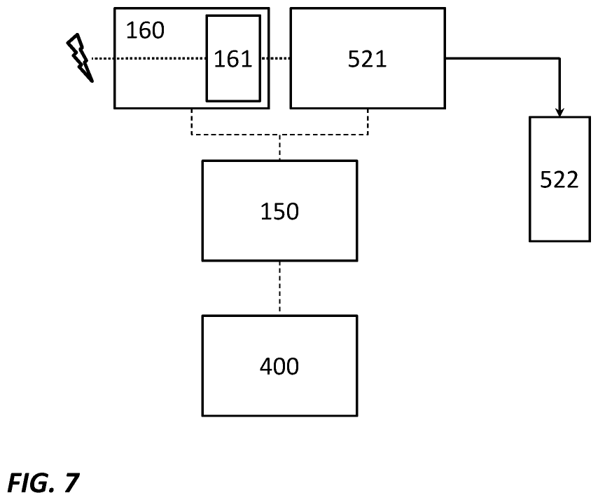

As can be seen for example in FIG. 2A, the entrance opening 304 of the cavity 310 is located in a first upper surface 301 of the cup holder 300. This first upper surface 301 is formed by a bottom surface 301 in a recessed area 306 in a second upper surface 305 of the cup holder 300. In this arrangement the second upper surface 305 is thus located above the first upper surface 301 in a height direction H. In alternative embodiments, such as for example shown in FIGS. 7A and 7B, the cup holder 300 can also be provided with a single flat first upper surface 301. The first upper surface 301 being located in the recessed area 306 is however advantageous for containing liquid mixture or frozen food product which is spilled accidentally out of the cup 200 in the recessed area 306, such that it is prevented from further spreading over the device 100.

The device 100 also comprises a cooling unit 400, as can be seen in FIGS. 1A and 1B and shown in more detail in FIGS. 2A and 2B. The cooling unit 400 is arranged for cooling the cavity 310 of the cup holder 300, and more specifically for cooling a. cup 200 received in the cavity 310. The cooling unit 400 should be arranged to provide sufficient cooling for freezing liquid mixture contained in the cup 200 while preparing a frozen food product from the liquid mixture. The cooling unit 400 may comprise one or more cooling pipes, which are arranged around the cavity 310, and through which a cooling fluid is transported for cooling the cavity 310. The cooling unit 400 may however also be arranged in any other way know to the person skilled in the art for cooling the cavity 310 of a device 100 for preparing a frozen food product from a liquid mixture.

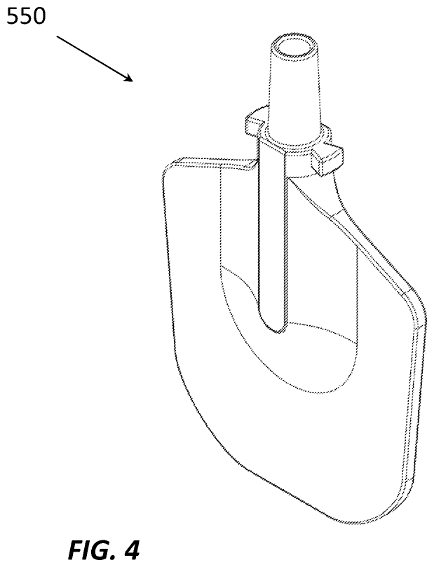

The device 100 also comprises a stirring unit 500 which is arranged above the cup holder 300, as can be seen in FIGS. 1A and 1B. The stirring unit 500 comprises a stirring element 550, which is shown in detail in FIG. 4. The stirring unit 500 is configured for stirring the liquid mixture in the cup 200 by said stirring element 550 for preparing the frozen food product. The stirring element 550 is removably connectable to the stirring unit 500, such that the stirring element 550 can be taken out of the device 100 for cleaning.

The stirring unit 500 comprises a moveable portion 501 which is moveable along a height direction H between a first position and a second position. In the first position, as shown for first sub-unit 101 of the device 100 in FIGS. 1A and 1B, the stirring element 550 is arranged outside of the cup 200, such that it is easily accessible for disconnecting it from the stirring unit 501 for cleaning and for connecting it to the stirring unit 500. In the second position, as shown for the second sub-unit 102 of the device 100 in FIGS. 1A and 1B, the stirring element 550 is arranged inside the cup 200 such that the stirring unit 500 can stir the liquid mixture in the cup 200 by the stirring element 550 for preparing the frozen food product.

The stirring unit 500 is also provided with a protection screen 510, which is shown for both sub-units 101, 102 of the device 100 in FIG. 1A and for the second sub-unit in FIG. 1B. In FIG. 1B, the protection screen 510 has however been omitted for the first sub-unit 101 of the device 100, but only to show the features of the device 100 located behind the protection screen 510. The protection screen 510 extends downwards from the moveable portion 501 of the stirring unit 500, and moves together with the moveable portion 501 of the stirring unit 500. When the moveable portion 501 of the stirring unit 500 is in the second position, the protection screen 510 closes off an area located above the cup 200 and between the cup holder 300 and the moveable portion 501 of the stirring unit 500. This prevents access to the moving stirring element 550 when the frozen food product is being prepared, which is beneficial for safety. A further safety feature is that, in the second position of the moveable portion 501 of the stirring unit 500, the bottom edge 511 of the protection screen 510 supports on the first upper surface 301 near an edge 307 of the recessed area 306, such that it is difficult to get underneath the protection screen 510 and lift it up to gain access to the closed off area. The protection screen 510 is also beneficial for the cleanliness of the device 100, since it contains spilled liquid mixture or frozen food product in the closed off area, and prevents it from further spreading over the device 100.

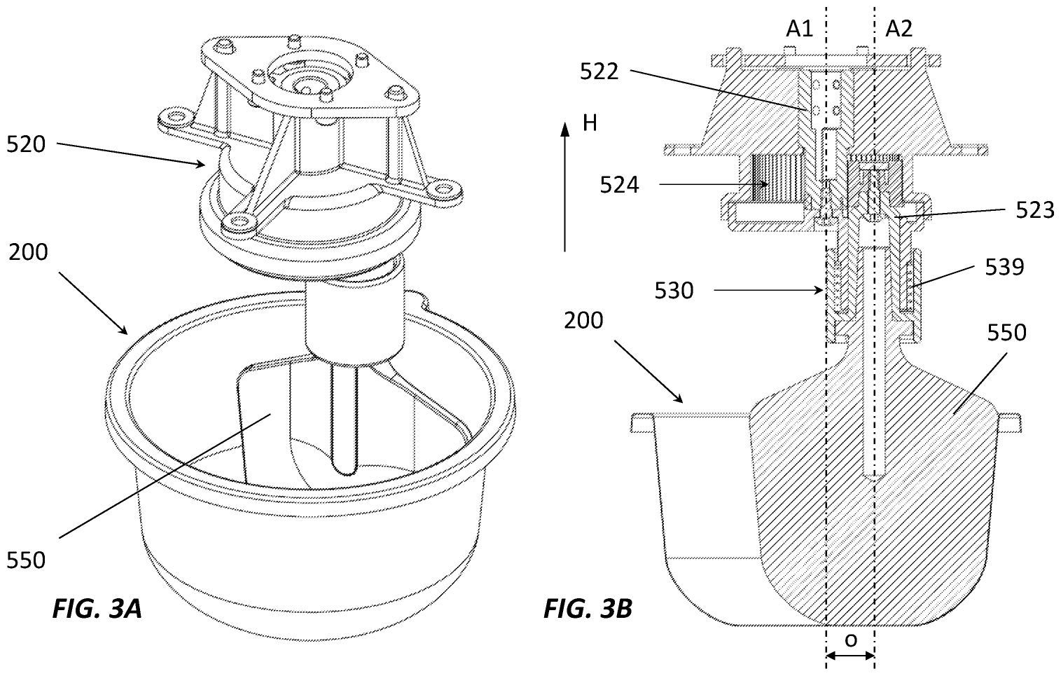

The stirring unit 500 also comprises a drive system 520 for driving the stirring motion of the stirring element 550 in the cup 200, which drive system 520 is shown in detail in the FIGS. 3A and 3B. The drive system 520 comprises an electrical motor 521, which is shown in the schematic representation of FIG. 7. The motor 521 is coupled to a first rotation shaft 522 for rotating the first rotation shaft 522. The first rotation shaft 522 is arranged in the height direction H along a first axis Al, which goes centrally through the cup 200 when received in the cavity 310 of the cup holder 300. The first rotation shaft 522 is connected to a secondary rotation shaft 523 by a planetary gear mechanism 524. The secondary rotation shaft 523 is arranged in the height direction H along a second axis A2, which goes centrally through the stirring element 550. The second axis A2 is located at a predetermined offset o from the first axis A1. The stirring element 550 is connected to the second rotation shaft 523 by a coupling mechanism 530. In this configuration, the motor 521 rotating the first rotation shaft 522 causes the rotation of the stirring element 550 together with the second axis A2 around the first axis A1 and simultaneously the rotation of the stirring element 550 around the second axis A2. In alternative embodiments, other configurations of the drive mechanism may be used for rotating the stirring element 550, such as for example a drive mechanism with a single rotation shaft for rotating the stirring element 550 around a single axis.

The coupling mechanism 530 for connecting the stirring element 550 to the second rotation shaft 523 is provided with a. spring 539 or other biasing element which is arranged for pushing the stirring element 550 downwards. This spring 539 causes the stirring element 550 to be pushed firmly against the cup 200 when the moveable portion 501 of the stirring unit 500 is in the second position, such that there is a. good contact between the stirring element 550 and the cup 200 for scraping frozen liquid mixture from the cup wall 210 when frozen food product is being prepared from the liquid mixture in the cup 200.

The device 100 further comprises a torque sensor 160, which is shown in the schematic representation of FIG. 7. The torque sensor 160 is configured for measuring a torque applied by the motor 521 of the drive system 520 of the stirring unit 500 for driving the stirring motion of the stirring element 550 in the cup 200. Therefore, the torque sensor 160 comprises a current sensor 161 arranged on an electrical connection between a power source and the motor 521. The current sensor 161 is configured for measuring the electrical current that is going from the power source to the motor 521. This electrical current is indicative of the torque applied by the motor 521, since the motor 521 requires more power, i.e. electrical current, from the power source for applying an increasing torque. The torque sensor 160 may be configured to convert the measured electrical current to the torque applied by the motor 521, but alternatively the torque sensor 160 may be configured to directly output the measured electrical current and the conversion to the torque applied by the motor 521 may then be done by a control unit 150 of the device 100. In alternative embodiments, the torque sensor 160 may however be provided in any other suitable manner known to the skilled person for measuring the torque applied by the motor 521.

The device 100 further comprises a control unit 150, which is shown in the schematic representation of FIG. 7. The control unit 150 is configured for operating the device 100. The control unit 150 is operatively connected to the cooling unit 400 for starting and stopping the cooling unit 400 cooling the cavity 310 of the cup holder 300. The control unit is 150 is also operatively connected to the motor 521 of the drive system 520 of the stirring unit 500 for starting and stopping the motor 521 driving the stirring motion of the stirring element 550. The control unit 150 is also operatively connected to the torque sensor 160 for retrieving torque values measured by the torque sensor 160. The control unit 150 can also be operatively connected to other components of the device 100, and be configured to perform further functions than the ones described above.

The device 100 is configured for determining during an operational phase of the device 100 in which the frozen food product is being prepared from the liquid mixture, the type of frozen food product, i.e. ice cream or sorbet, that is being prepared, and to set a corresponding termination phase of the operational phase to get ice cream or sorbet with the right consistency for eating.

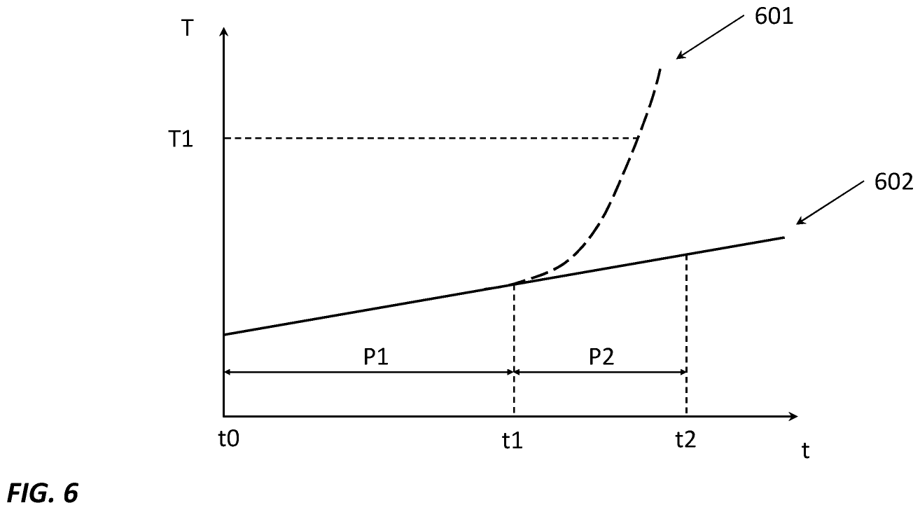

Therefore, the device 100 makes use of how the consistency of the liquid mixture for the frozen food product changes over time while preparing the frozen food product, and thus how the torque 601, 602 that has to be applied by the motor 521 for driving the stirring motion of the stirring element 550 changes over time. This change, as illustrated in the graph of FIG. 6, is different for a liquid mixture for ice cream than for a liquid mixture for sorbet. Initially, the torque 601 for the liquid mixture for ice cream and the torque 602 for the liquid mixture for sorbet increase linearly over time in a first period between a start time to and a first time t1. After the first time, however, the torque 601 for the liquid mixture for ice cream starts to rise significantly with respect to the linear increase of the torque 601 for the liquid mixture for ice cream in the first period P1, whereas after the first time t1 the torque 602 for the liquid mixture for sorbet keeps increasing linearly in the same manner as in the first period P1.

Now, when a cup 200 is received in the cavity 310 of the cup holder 300 of the device 100 with a liquid mixture for a frozen food product of a yet unknown type, and the control unit 150 receives from a user of the device 100 instructions for starting the operational phase for preparing the frozen food product from the liquid mixture, for example by pushing an activation button on the device 100, then the control unit 150 starts the operational phase of the device 100 by activating the cooling unit 400 for cooling the cavity 310 of the cup holder 300 in which the cup 200 is received and by activating the motor 521 for driving the stirring motion of the stirring element 550 in the cup 200.

While the liquid mixture in the cup 200 is being cooled an stirred, the control unit 150 starts monitoring by the torque sensor 160 the torque that is applied by the motor 521 for driving the stirring motion of the stirring element 550, and this in the first period P1 between the start time to of the operational phase and the predetermined first time t1, as shown in the graph of FIG. 6. From the torque monitored in the first period P1, the control unit 150 then determines the linear increase of the torque in the first period P1. These steps may for example be performed by the control unit 150 retrieving a plurality of torque values from the torque sensor 16 at different times in the first period P1, and then fitting a line to the retrieved torque values to determine the linear increase of the torque, it should however be clear that any other suitable method for determining the linear increase can be used.

After the first time t1 the control unit 150 keeps monitoring by the torque sensor 160 the torque that is applied by the motor 521 for driving the stirring motion of the stirring element 550. If the torque monitored after the first time ti then increases above a predetermined threshold with respect to the linear increase determined from the torque monitored in the first period. P1, then the control unit 150 determines that the frozen food product being prepared is ice cream and the control unit 150 initiates a termination phase for ice cream, if the torque monitored after the first time t 1 does not increase above the predetermined threshold with respect to the linear increase determined from the torque monitored in the first period P1, then the control unit 150 determines that the frozen food product being prepared is sorbet and the control unit 150 initiates a termination phase for sorbet. These steps may for example be performed by the control unit 150 retrieving a single torque value from the torque sensor 16 at a certain time after the first time t1, and by comparing the retrieved torque value with respect to the line fitted to the retrieved torque values in the first period. If the retrieved value is then at least the predetermined threshold above the fitted line, then it is determined that the frozen food product being prepared is ice cream, and otherwise it is determined that the frozen food product being prepared is sorbet. Hereby, the predetermined threshold may for example be a pre-set fixed threshold, but may also be based on a standard deviation of at least one parameter of the line fitted to the retrieved torque values in the first period P1. The control unit 150 may however also retrieve a plurality of torque values from the torque sensor 160 at a different times after the first time t1, which gives a clearer picture of the change in the torque after the first time t1 and improves the accuracy correctly determining the type of frozen food product that is being prepared.

In the termination phase for ice cream the control unit 150 keeps monitoring by the torque sensor 160 the torque that is applied by the motor 521 for driving the stirring motion of the stirring element 550, and if the monitored torque reaches a predetermined first torque value T1 at which the ice cream has the right consistency for eating, then the control unit 150 instructs the cooling unit 400 to stop cooling the cavity 310 of the cup holder 300 and the motor 521 to stop driving the stirring motion of the stirring element 550 in the cup 200.

In the termination phase for sorbet the control unit 150 waits for a predetermined second period P2 of approximately 30 seconds after the first time t1 at which the sorbet has the right consistency for eating, and then the control unit 150 instructs the cooling unit 400 to stop cooling the cavity 310 of the cup holder 300 and the motor 521 to stop driving the stirring motion of the stirring element 550 in the cup 200.

### REFERENCES

100 device
150 control unit
160 torque sensor
161 current sensor
200 cup
201 holding volume
202 top opening
210 cup wall
300 cup holder
301 first upper surface
304 entrance opening
305 second upper surface
306 recessed area
307 edge
310 cavity
400 cooling unit
500 stirring unit
501 moveable portion
510 protection screen
511 bottom edge
520 drive system
521 motor
522 first rotation shaft
523 second rotation shaft
524 planetary gear mechanism
530 coupling mechanism
539 spring
550 stirring element
601 torque ice cream
602 torque sorbet

1. A device for preparing a frozen food product from a liquid mixture, the device, comprising:
a cup holder comprising a cavity for releasable receiving a cup in which the frozen food product is to be prepared from the liquid mixture in an operational phase of the device;
a cooling unit configured for cooling the cavity of the cup holder in the operational phase;
a stirring unit configured for stirring the liquid mixture in the cup with a stirring element in the operational phase for preparing the frozen food product, wherein the stirring unit comprises a drive system for driving a stirring motion of the stirring element in the cup with a motor;
a control unit configured for operating the device, wherein the control unit is at least operatively connected to the cooling unit and to the motor of the drive system of the stirring unit; and
a torque sensor configured for measuring a torque applied by the motor,
wherein the control unit is further operatively connected to the torque sensor,
wherein the control unit is configured for:
starting the operational phase of the device by activating the cooling unit for cooling the cavity of the cup holder, and by activating the motor for driving the stirring motion of the stirring element in the cup;
monitoring, in a first period of the operational phase between the start of the operational phase and a predetermined first time, with the torque sensor, the torque applied by the motor for driving the stirring motion of the stirring element in the cup, and determining a linear increase of the torque monitored in the first period;
monitoring, after the first time, with the torque sensor, the torque applied by the motor for driving the stirring motion of the stirring element in the cup, and if with respect to the linear increase of the torque determined in the first period an increase above a predetermined threshold occurs in the torque monitored after the first time, then initiate a termination phase for ice cream, otherwise initiate a termination phase for sorbet.

2. The device according to claim 1, wherein the termination phase for ice cream comprises monitoring with the torque sensor the torque applied by the motor for driving the stirring motion of the stirring element in the cup, and stopping the operational phase when the torque monitored in the termination phase for ice cream reaches a predetermined first torque.

3. The device according to claim 1, wherein the termination phase for sorbet comprises stopping the operational phase a predetermined second period after the first time.

4. The device according to claim 2, wherein stopping the operational phase comprises instructing the cooling unit to stop cooling the cavity of the cup holder, and instructing the motor to stop driving the stirring motion of the stirring element in the cup.

5. The device according to claim 1, wherein monitoring the torque in the first period comprises measuring at least two torque values at different times in the f5irst period with the torque sensor.

6. The device according to claim 5, wherein determining the linear increase of the torque monitored in the first period comprises fitting a line to the measured at least two torque values.

7. The device according to claim 6, wherein the predetermined threshold is based on a standard deviation of at least one parameter of the line fitted to the measured at least two torque values.

8. The device according to claim 1, wherein monitoring the torque after the first time comprises measuring at least one torque value at different times after the first time.

9. The device according to claim I, wherein monitoring the torque after the first time is done in a first 50% of a predetermined second period after the first time, and wherein monitoring the torque after the first time is done after a first 5% of a predetermined second period after the first time.

10. The device according to claim I, wherein the motor is an electrical motor, wherein the torque sensor comprises a current sensor for measuring an electrical current going to the motor, and wherein at least one of the torque sensor and the control unit is configured for determining from the electrical current measured by the current sensor the torque applied by the motor.

11. A method for operating the device according to claim 1, comprising:
starting, with the control unit, the operational phase of the device by activating the cooling unit for cooling the cavity of the cup holder, and by activating the motor for driving the stirring motion of the stirring element in the cup
monitoring, in a first period of the operational phase between the start of the operational phase and a predetermined first time, with the torque sensor the torque applied by the motor for driving the stirring motion of the stirring element in the cup, and determining a linear increase of the torque monitored in the first period; and
monitoring, after the first time, with the torque sensor, the torque applied by the motor for driving the stirring motion of the stirring element in the cup, and if with respect to the linear increase of the torque determined in the first period an increase above a predetermined threshold occurs in the torque monitored after the first time, then initiate a termination phase for ice cream, otherwise initiate a termination phase for sorbet.

12. The method according to claim 11, wherein the termination phase for ice cream comprises monitoring with the torque sensor the torque applied by the motor for driving the stirring motion of the stirring element in the cup, and stopping the operational phase when the torque monitored in the termination phase for ice cream reaches a predetermined first torque.

13. The method according to claim 12, wherein stopping the operational phase comprises instructing the cooling unit to stop cooling the cavity of the cup holder, and instructing the motor to stop driving the stirring motion of the stirring element in the cup.

14. The method according to claim 11, wherein the termination phase for sorbet comprises stopping the operational phase a predetermined second period after the first time.

15. The method according to claim 14, wherein stopping the operational phase comprises instructing the cooling unit to stop cooling the cavity of the cup holder, and instructing the motor to stop driving the stirring motion of the stirring element in the cup.

16. The method according to claim 11, wherein monitoring the torque in the first period comprises measuring at least two torque values at different times in the first period by the torque sensor.

17. The method according to claim 16, wherein determining the linear increase of the torque monitored in the first period comprises fitting a line to the measured at least two torque values.

18. The method according to claim 17, wherein the predetermined threshold is based on a standard deviation of at least one parameter of the line fitted to the measured at least two torque values.

19. The method according to claim 11, wherein monitoring the torque after the first time comprises measuring at least one torque value at different times after the first time.

20. The method according to claim 11, wherein monitoring the torque after the first time is done in a first 50% of a predetermined second period after the first time, and wherein monitoring the torque after the first time is done after a first 5% of a predetermined second period after the first time.
